(19) United States
(12) Patent Application Publication
(10) Pub. No.: US 2010/0330379 A1
(43) Pub. Date: Dec. 30, 2010

(54) METHOD FOR PRODUCING TOPCOAT ADDITIVES

(76) Inventors: Charles G. Hadfield, Berkley, MI (US); Cynthia M. Schroeder, Garden City, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 12/667,060

(22) PCT Filed: Jun. 27, 2008
(86) PCT No.: PCT/US08/68527

§ 371 Date: Dec. 29, 2009

Related U.S. Application Data
(60) Provisional application No. 60/947,107, filed on Jun. 29, 2007.

(51) Int. Cl. B32B 9/04; C04B 14/04; C08K 3/34; C09D 183/04; C14C 9/00

(52) U.S. Cl. 428/447; 106/481; 524/442; 106/287.16; 252/8.57

(57) ABSTRACT

A topcoat additive for addition to a topcoat. The topcoat additive includes a liquid thermoplastic polymer emulsified in an emulsifier to obtain a liquid thermoplastic emulsion. The liquid thermoplastic polymer is a silicone thermoplastic polymer including an Si—O backbone. The silicone thermoplastic polymer may be a polydimethylsiloxane (PDMS) thermoplastic polymer.

### BACKGROUND

1. Technical Field

One aspect of the present invention relates to a method for producing a topcoat additive for use in a topcoat mixture for treating materials having soft surfaces, such as leather.

2. Background Art

Materials having soft surfaces, such as leather, are processed from a raw material to a processed material through a manufacturing process. A typical leather manufacturing process for processing leather hide or skin (otherwise referred to collectively as “leather material”) may include four main processing steps: preparation, tanning, crusting and topcoat application. The preparation step prepares a leather material for tanning. Non-limiting examples of preparation steps include preservation, soaking, degreasing, bleaching and pickling. The tanning step may include penetration and fixation, and is commonly used to stabilize the fibers of the leather material for resistance to bacterial attack and/or to enhance the flexibility of the leather material on drying. The crusting step may include thinning and lubricating the leather material, and typically further includes drying and softening of the leather material. The topcoat application, otherwise referred to as finishing, involves the application of a topcoat to the tanned and/or crusted leather to impart finished properties onto the leather material.

### SUMMARY

One aspect of the present invention relates to a method for producing a topcoat additive for use in a topcoat mixture for treating materials having soft surfaces, such as leather. Another aspect of the present invention relates to a method for producing a topcoat mixture including an additive. Yet another aspect of the present invention relates to a method for treating a material having a soft surface with a topcoat mixture to impart one or more finished properties onto the treated material. In at least one embodiment, the topcoat mixture forms a relatively strong bond with the soft surface.

According to a first embodiment of the present invention, a PDMS emulsion is produced. According to a second embodiment of the present invention, a topcoat additive is produced including a PDMS emulsion.

These and other aspects of the present invention will be better understood in view of the following detailed description of the invention.

### DETAILED DESCRIPTION OF EMBODIMENTS

Except where expressly indicated, all numerical quantities in this description indicating amounts of material or conditions of reaction and/or use are to be understood as modified by the word “about” in describing the broadest scope of the present invention. Practice within the numerical limits stated is generally preferred.

The description of a single material, compound or constituent or a group or class of materials, compounds or constituents as suitable for a given purpose in connection with the present invention implies that mixtures of any two or more single materials, compounds or constituents and/or groups or classes of materials, compounds or constituents are also suitable. Also, unless expressly stated to the contrary, percent, “parts of,” and ratio values are by weight. Description of constituents in chemical terms refers to the constituents at the time of addition to any combination specified in the description, and does not necessarily preclude chemical interactions among constituents of the mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

One aspect of the present invention relates to a method for producing a topcoat additive for mixing with a topcoat for application to a material having a soft surface, such as a leather material, for example, a skin or a hide, or a vinyl material.

In at least one embodiment, the leather topcoat additive includes a liquid thermoplastic emulsion, such as an emulsification including a silicone polymer including a Si-0 backbone. For example, the leather topcoat additive may include a polydimethylsiloxane (PDMS) emulsion. PDMS has a chemical formula of (H₃C)[SiO(CH₃)₂]ₙSi(CH₃)₃, where “n” is the number of repeating monomer [SiO(CH₃)₂] units. In at least one embodiment, “n” can be in the range of 2 to 7. In other embodiments, “n” can be in the range of 3 to 4. It should be appreciated that the PDMS used in the emulsion can include one or more PDMS compounds having different “n” values. Moreover, the PDMS can be linear or cross-linked. Suitable PDMSs for use in one or more embodiments of the present invention can be obtained from Dow Corning Corp. of Midland, Mich.

According to one embodiment, the specific PDMS is selected for use with topcoat applications based on one or more of the following characteristics: opacity, flexibility of the polymer chain, viscosity, usefulness as an antifoaming agent and/or usefulness as a naturally occurring emulsifier.

PDMSs are available in a range of viscosities from relatively thin liquids to relatively thicker, rubbery semi-solid states where “n” is relatively high. In at least one embodiment, the viscosity can be in the range of 1 to 20 centistrokes (sc). In other embodiments, the viscosity can be in the range of 3.0 to 4.5 cs. In yet other embodiments, the viscosity can be in the range of 2.0 to 6.0 cs.

In at least one embodiment, the PDMS is emulsified in an emulsifier, for example, SiOH (silanol), so that the PDMS achieves a suspended state. According to one emulsification process of an embodiment of the present invention, the PDMS is placed in a heated mixing tank where the temperature of the PDMS is brought up to 115° C. and then the elevated temperature is maintained for 30 minutes. In another embodiment, the PDMS can be heated to an elevated temperature of 70 to 125° C. and the elevated temperature can be maintained for 0 to 120 minutes, or 10 to 60 minutes.

In at least one embodiment, 5.0% by weight of silanol to the total weight of PDMS is used in the emulsification. In other embodiments, 2 to 7% by weight of silanol or other emulsifier to the total weight of PDMS can be utilized. The 5.0% by weight of silanol can be divided into three substantially equal parts. One part of the silanol at room temperature (RT) or other emulsifier can be added to the PDMS, which has been maintained at an elevated temperature maintained for a suitable period, e.g., 30 minutes, and then the resulting mixture can be blended for 30 minutes, although in some embodiments, the resulting mixture can be blended for 20 to 60 minutes. Advantageously, once the one part of silanol is added to and blended with the PDMS, then water and/or alcohol solvents can be freely mixed with the blended silanol and PDMS.

Next, the remaining two parts of the silanol or other emulsifier and/or water equal to the volume of the 5.0% by weight of silanol can be added to the blended mixture of one part silanol and PDMS. This resulting mixture can be blended for an additional 60 minutes (and in some embodiments, 45 to 90 minutes) at a relatively low speed of 70 rotations per minute (rpm) (and in some embodiments, 50 to 120 rpm) with a lightning mixer or other suitable mixer to form the PDMS emulsion.

At this point, one or more organic polymers can be added to the PDMS emulsion. In at least one embodiment, one or more clear organic polymers are employed. The weight of the one or more organic polymers is substantially equal to the weight of the PDMS (originally charged to the mixing tank) can be added to the PDMS emulsion. In other embodiments, the weight ratio of the one or more organic polymers to the originally charged PDMS is 0.5 to 1.5. The mixture of the PDMS emulsion and the one or more organic polymers is blended for 30 minutes.

At this point, additional components can be added to the PDMS emulsion, including, but not limited to, ester of montanic acid, sodium tetraborate decahydrate, sodium hydroxide and/or water. In at least one embodiment, external heating of the mixing vessel is turned off and the mixture is blended until the mixture reaches room temperature, or about 2 to 6 hours, and under certain operating conditions, 4 hours.

The one or more sodium ingredients are used to aid in the release of soils and stains trapped in the top layer of a soft surface material treated with a topcoat containing an additive of one or more embodiments of the present invention. Beneficially, cleaning of the treated material may be easier when the sodium compounds in the additive are matched with the sodium compounds of the cleaning solution, especially if the cleaning solution has soil and stain quick release characteristics.

In at least one embodiment, the additive includes the following materials at the identified weight ranges as set forth in table 1. This formulation is referred to as CCO370 in Table 3.

TABLE 1

| Wt. % | Material | CAS No. |
|---|---|---|
| 25% | PDMS emulsion | 63148-62-9 |
| 20% | Ester of Montanic Acid | 73138-45-1 |
| 8% | Sodium Tetraborate Decahydrate | 1303-96-4 |
| 8% | Sodium Hydroxide | 1310-73-2 |
| 39% | Water | 7732-18-5 |

In another embodiment, the weight ranges of the additive materials can be varied based on operating conditions during mixing or applicable implementation of the additive. Table 2 discloses additive material weight ranges according to certain embodiments of the present invention.

TABLE 2

| Wt. % | Material | CAS No. |
|---|---|---|
| 10-20% | PDMS emulsion | 63148-62-9 |
| 15-25% | Ester of Montanic Acid | 73138-45-1 |
| 0-10% | Sodium Tetraborate Decahydrate | 1303-96-4 |
| 0-10% | Sodium Hydroxide | 1310-73-2 |
| 30-40% | Water | 7732-18-5 |

The resulting PDMS emulsion is highly compatible with urethanes typically included in topcoats. Therefore, the resulting PDMS emulsion blends work well with a wide range of topcoats.

In at least one embodiment, PDSM can be used in combination with water and/or organic solvents, such as alcohol, without material defamation to create an emulsion that can be used in combination with topcoats for treating and protecting materials having soft surfaces such as leather and/or vinyl materials. In certain embodiments, these inventive formulations allow for the use of organic solvents that do not stiffen the soft surface material, thereby allowing water to infiltrate the soft surface, and promoting polymer bonding between the polymers in the topcoat and/or topcoat additive and the soft surface material.

Another aspect of the present invention relates to a method for producing a topcoat including an additive. In at least one embodiment, the additive is added to a topcoat such that the resulting volume is 30% additive and 70% topcoat. In other embodiments, the additive can be present in a volume of 10 to 40% of the total topcoat and additive mixture. Advantageously, the additives of one or more embodiments of the present invention can be utilized with both aqueous based and solvent based topcoats.

In another embodiment, the volume parts of the additive and topcoat mixture can be varied based on operating conditions during mixing or applicable implementation of the additive and topcoat mixture, e.g. type of finish of flat, matte, semi-glossy or glossy. Table 3 discloses volume part ranges for an additive and topcoat mixture according to certain embodiments of the present invention. These mixtures are especially suitable for flat or matte finishes, although it should be appreciated that additional parts of bright urethane can be added to provide semi-glossy or glossy finishes. Table 4 discloses volume part ranges for an additive and topcoat mixture especially suitable for a matte finish.

TABLE 3

| Volume Parts | | Material | Product Name | Supplier |
|---|---|---|---|---|
| 3-4 | parts | Water | 6.5-7.5 pH | Tap water |
| 1-2 | parts | Bright Urethane | RU 40-439 | Stahl |
| 3-4 | parts | Dull Urethane | WD-21-163 | Stahl |
| 1-3 | parts | Soft Urethane | RU 6125 | Stahl |
| 1 | part | Silicone | HM354 | Stahl |
| 0.5-1 | part | Leveling Agent | LA 746 | Stahl |
| 1-2 | parts | Cross Linking Agent | XR 21443 | Stahl |
| 3-4 | parts | PDMS emulsion | CC0370 | Crypton Inc. |

TABLE 4

| Volume Parts | | Material | Product Name | Supplier |
|---|---|---|---|---|
| 4 | parts | Water | 6.5-7.5 pH | Tap water |
| 1 | part | Bright Urethane | RU 40-439 | Stahl |
| 3.5 | parts | Dull Urethane | WD-21-163 | Stahl |
| 2 | parts | Soft Urethane | RU 6125 | Stahl |
| 1 | part | Silicone | HM354 | Stahl |
| 0.5 | part | Leveling Agent | LA 746 | Stahl |
| 1 | parts | Cross Linking Agent | XR 21443 | Stahl |
| 3 | parts | PDMS emulsion | CC0370 | Crypton Inc. |

The bright, dull and soft urethanes are available from various chemical manufactures, such as Stahl of St. Clair Shores, Mich., Dow or DuPont of Wilmington, Del. Typical producers of cross-linking agents and levelers are Stahl, Dow Corning and DuPont. The silicone can be a non-automotive application silicone.

Yet another aspect of the present invention relates to a method for treating leather or other material with a soft surface with a topcoat including an additive. The topcoat and additive mixtures disclosed above can be applied to any material having a soft surface, such as leather, to protect the material and to enhance the cleanability of the material. Non-limiting examples of application operations include, spraying, roller coating, curtain coating, polishing and/or glazing. The finished product includes a solid residue of the topcoat and additive mixture. The solid residue can be in the range of 2 to 8, or 3 to 7, or 4 to 6 weight percent of the weight of one square yard of the material. The PDMS solid residue can be in the range of 2 to 6, or 2.2 to 5.5 weight percent of the weight of one square yard of the material.

### Example 1

A light cashmere material was treated with a topcoat additive mixture including 30% CCO370 Crypton PDMS Solution.

The treated material was tested using various test methods. The test results are presented below in Table 5, and shown satisfactory finishing of the light cashmere material.

TABLE 5

| TEST | TEST CONDITION | TEST METHOD | REQUIREMENT | TEST RESULTS | DISPOSITOIN |
|---|---|---|---|---|---|
| Resistance to | Regular | ASTM D 3884 | There shall be no rupture | No effect in the | Pass |
| Wear | Construction (500 g | | of the leather finish. Loss | topcoat | |
| | weight, 300 cycle, | | of gloss is acceptable, but a | | |
| | H-19 Wheel, S-36 | | complete color change or | | |
| | Mounting Card) | | exposure of the russet at | | |
| | | | 10X magnification is no | | |
| | | | acceptable | | |
| | 3 lb Load and 4 lb | SAE J 1530 | There shall be no rupture | No effect in the | Pass |
| | Tension, 4000 | | of the leather finish. Loss | topcoat | |
| | cycles, #8 Style 474 | | of gloss is acceptable. | | |
| | cotton duct abradant. | | | | |
| Cold Crack | Condition the equipment | ASTM D 1912 | Examine the specimen | No effect in the | Pass |
| Resistance, | and specimens for a | | along the area that was | topcoat | |
| Seating & | minimum of 4 h at −30 +/− | | folded during the test at | | |
| Shift Boot | 2° C. prior to testing. | | 10X magnification. | | |
| Use | Test specimens at −30 +/− | | There shall be no cracking, | | |
| | 2° C. | | peeling of the coating | | |
| | | | or other deterious effects. | | |
| Coating | 2 h of flex testing | ASTM D 2097 | The flexed specimen shall | No effect in the | Pass |
| Adhesion | | | show no more than slight | topcoat | |
| (Seating and | | | crazing. There shall be | | |
| Boot Use) | | | no cracks when evaluated | | |
| | | | under 10 X magnification | | |
| Resistance | Window Cleaner | GM 9900P | Color transfer to | Satisfactory | Pass |
| to Consumer | Fantastic | | cheesecloth gray scale | Satisfactory | Pass |
| Cleaning | Armor Cleaner | | for staining of 4 or | Satisfactory | Pass |
| | Formula 409 | | greater, no more than | Satisfactory | Pass |
| | Armor All Protectant | | | Satisfactory | Pass |
| | Saddle Soap | | | Satisfactory | Pass |
| Colorfastness | Test to 451.2 kk/m2 | SAE J 1885 | A noticeable value (lightness | Satisfactory | Pass |
| to light | at 340 nm | | and/or chroma (saturation) | | |
| | | | change with minimum hut | | |
| | | | change is acceptable | | |
| Colorfastness | 93 +/− 2° C. for 72 h | GM 2576 M | There shall be no hue | Val. EG | Pass |
| to elevated | | 3.3.16 | change when compared | 4.72 AATC | |
| temperature | | | with an “as received” | Punt. EG | |
| | | | piece of leather” | | |

### Example 2

Leather samples were treated with various mixtures of an additive and topcoat. The addition included 10-30% CCO370 Crypton emulsion. The topcoat included 70-90% of the total mixture. The leather samples were taken from hides treated with a basecoat, embossed and milled. A color coat and the topcoat additive mixture were sprayed onto the leather samples with a high-pressure spray gun available from Graco of Minneapolis, Minn. No viscosity, gloss or color adjustments were made between the various mixtures. The concentration of additive pigment mix, resin and auxiliary from gloss were varied between the various mixtures.

The treated material was tested using various test methods. The test results are presented below in Tables 6 and 7, and shown satisfactory finishing of the leather samples. L refers to square inches in the Tables 6 and 7.

TABLE 6

| | Sample | | | | | | | |
|---|---|---|---|---|---|---|---|---|
| | Leather sample A | | | | Leather sample B | | | |
| | (830K WGNEDG) | | | | (830K WGMEGB) | | | |
| % Additive | 0 | 10 | 20 | 30 | 0 | 10 | 20 | 30 |
| L | 59.86 | 59.98 | 60.13 | 60.07 | 60.13 | 60.33 | 60.48 | 60.59 |
| Gloss | 2.6 | 2.7 | 2.8 | 2.8 | 1.7 | 1.8 | 1.8 | 1.9 |
| Bubbles | NO | NO | NO | NO | NO | NO | NO | NO |
| Separate | NO | NO | NO | NO | NO | NO | NO | NO |
| Curing t (Hrs) | 18 | 18 | 18 | 18 | 18 | 18 | 18 | 18 |
| Drying T (° C.) | 85 | 85 | 85 | 85 | 85 | 85 | 85 | 85 |
| Drying t (Min) | 2.5 | 2.5 | 2.5 | 2.5 | 2.5 | 2.5 | 2.5 | 2.5 |

TABLE 7

| | Sample | | | | | | | |
|---|---|---|---|---|---|---|---|---|
| | Leather Sample C | | | | Leather Sample D | | | |
| | (167A WGNEDG) | | | | (167A WGNEGB) | | | |
| % Additive | 0 | 10 | 20 | 30 | 0 | 10 | 20 | 30 |
| L | 25.44 | 26.04 | 26.52 | 26.6 | 25.1 | 25.77 | 20.06 | 26.31 |
| Gloss | 2.4 | 2.3 | 2.3 | 2.8 | 1.1 | 1.1 | 1.2 | 1.3 |
| Bubbles | NO | NO | NO | NO | NO | NO | NO | NO |
| Separate | NO | NO | NO | NO | NO | NO | NO | NO |
| Curing t (Hrs) | 18 | 18 | 18 | 18 | 18 | 18 | 18 | 18 |
| Drying T (° C.) | 85 | 85 | 85 | 85 | 85 | 85 | 85 | 85 |
| Drying t (Min) | 2.5 | 2.5 | 2.5 | 2.5 | 2.5 | 2.5 | 2.5 | 2.5 |

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

As required, detailed embodiments of the present invention are disclosed herein. However, it is to be understood that the disclosed embodiments are merely exemplary of an invention that may be embodied in various and alternative forms. Therefore, specific functional details disclosed herein are not to be interpreted as limiting, but merely as for teaching one skilled in the art to variously employ the present invention.

What is claimed is:

1. A topcoat additive comprising:
a liquid thermoplastic polymer emulsified in an emulsifier to obtain a liquid thermoplastic emulsion, wherein the liquid thermoplastic polymer is a silicone thermoplastic polymer including an Si-0 backbone.

2. The topcoat additive of claim 1, wherein the emulsifier is silanol.

3. The topcoat additive of claim 2, wherein the liquid thermoplastic emulsion includes 2 to 7% by weight of silanol to the total weight of the liquid thermoplastic polymer in the liquid thermoplastic emulsion.

4. The topcoat additive of claim 3, wherein the liquid thermoplastic emulsion includes 5% by weight of silanol to the total weight of the liquid thermoplastic polymer in the liquid thermoplastic emulsion.

5. The topcoat additive of claim 1, wherein the silicone thermoplastic polymer is a polydimethylsiloxane (PDMS) thermoplastic polymer.

6. The topcoat additive of claim 5, wherein the PDMS has a chemical formula of (H₃C)[SiO(CH₃)₂]ₙSi(CH₃)₃ and n is in the range of 2 to 7.

7. The topcoat additive of claim 6, wherein n is in the range of 3 to 4.

8. The topcoat additive of claim 1, further comprising one or more organic polymers.

9. The topcoat additive of claim 1, further comprising one or more sodium ingredients.

10. The topcoat additive of claim 1, further comprising water.

11. A leather treatment composition comprising:
a topcoat composition; and
a topcoat additive including a liquid thermoplastic polymer emulsified in an emulsifier to obtain a liquid thermoplastic emulsion, wherein the liquid thermoplastic polymer is a silicone thermoplastic polymer including an Si—O backbone.

12. The leather treatment composition of claim 11, wherein the volume of the leather treatment composition is comprised of 30% by volume of the topcoat additive and 70% by volume of the topcoat composition.

13. The leather treatment composition of claim 11, wherein the topcoat additive is comprised of 10 to 40% by volume of the total volume of the leather treatment composition.

14. The leather treatment composition of claim 11, wherein the topcoat composition includes a urethane polymer.

15. The leather treatment composition of claim 14, wherein the urethane polymer includes three different urethane polymers comprised of a bright urethane, a dull urethane and a soft urethane.

16. The leather treatment composition of claim 15, wherein the bright urethane is present in 1-2 volume parts relative to the dull urethane being present in 3-4 volume parts.

17. The leather treatment composition of claim 15, wherein the bright urethane is present in 1-2 volume parts relative to the soft urethane being present in 1-3 volume parts.

18. The leather treatment composition of claim 15, wherein the dull urethane is present in 3-4 volume parts relative to the soft urethane being present in 1-3 volume parts.

19. The leather treatment composition of claim 11, wherein the silicone thermoplastic polymer is a polydimethylsiloxane (PDMS) thermoplastic polymer.

20. A finished and treated leather product comprising:
a leather material having a first and second side;
a solid residue of polydimethylsiloxane (PDMS) thermoplastic polymer disposed on at least one of the first and second sides of the leather material.
